(19) United States
(12) Patent Application Publication
(10) Pub. No.: US 2018/0280903 A1
(43) Pub. Date: Oct. 4, 2018

(54) SUPERIOR PAINT AND FLUID STIRRING AND BLENDING DEVICE TO PUSH UP HEAVIER PAINT OR FLUID FROM THE CONTAINER'S BOTTOM TO THE TOP

(71) Applicant: Paul M Swamidass, Auburn, AL (US)

(72) Inventor: Paul M Swamidass, Auburn, AL (US)

(21) Appl. No.: 15/765,999

(22) PCT Filed: Mar. 16, 2016
(86) PCT No.: PCT/US2016/022546

§ 371 Date: Apr. 5, 2018

(30) Foreign Application Priority Data
Oct. 10, 2015 (US) 14880216

(51) Int. Cl. B01F 11/00; B01F 13/00; B01F 15/00; B01F 7/00; B44D 3/08

(52) U.S. Cl. CPC B01F 11/0082; B01F 13/0028; B01F 15/00506; B01F 7/00033; B44D 3/08; B01F 7/00341; B01F 7/004; B01F 7/00416; B01F 7/00583; B01F 7/001

(57) ABSTRACT

The purpose of stirring a can of paint or fluids before their use is to lift to the surface heavier paint matter that fall out of the solution and tend to settle to the bottom of the container. Manual paint mixing, blending and stirring paddles are flat and not mechanically designed to lift or push to the top of the container all the heavier paint/fluid matter settled to the bottom of the container. This invention is a device designed to lift or push up the heavier paint/fluid matter from the bottom to the surface while using a stirring or to-and-fro reciprocal motion. This manual device could be motorized to turn it at appropriate speeds in larger paint or fluid containers. One embodiment of this device can be attached or clipped to the foot of the common flat paint-stirring or blending paddle to transform it into a more effective paint mixing and blending tool.

### BACKGROUND

This application calls reference to U.S. patent application Ser. No. 14/880,216 dated Oct. 10, 2015.

### THE FIELD OF INVENTION

This invention pertains to mixing or stirring paints, stains and fluids that have allowed heavier substance to settle to the bottom of the container over time. Paint pigments tend to fall out of colloidal suspension and settle at the bottom of the container, and the purpose of stirring the paint prior to use is to replace the pigments back into the colloidal suspension.

When paints and fluids in containers are stored, heavier matter in them tend to settle to the bottom of containers. Before using the paints/stains/fluids for their intended purposes, it becomes imperative that the paint and fluids in the container are stirred to mix the heavier bottom-settled paint/fluid matter with rest of the fluid in the container to an uniform consistency.

### PRIOR ART

For the purpose of manual stirring of paint before use, stirring paddle is the most widely used device; examples being U.S. Pat. No. 1,732,714, U.S. Pat. No. 4,884,895 and an improved version of the paint stirrer paddle in U.S. Pat. No. 4,197,017. These paddles fall short of the intended purpose-they do not help lift or push up any and all settled paint/fluid from the bottom of the container to the top; as the paddles are moved with a stirring motion, paint moves sideways not upwards.

Current paint stirrers are inadequate. There is a need for a simple and elegant paint stirrer that would push up or lift heavier settled matter from the bottom to the top, and fluid from the top to the bottom.

### DESCRIPTION

Paints in general, and pigmented paints including metallic paints, acrylic lacquers and stains need proper mechanical stirring to replace and redistribute colloidal particles or pigments that tend to settle to the bottom of the container. The greatest challenge to paddles used for the purpose is the need to lift up settled matter from the bottom of the container to the top to enable blending the bottom-settled matter uniformly in the container.

The present invention is a stirring device designed for a novel and elegant way of moving heavier paint or liquid from the bottom of the paint/fluid container to the top, and to bring down the lighter fluid from the top of the container to the bottom to mix the paint or fluid uniformly.

This invention uses paint stirring paddles that are purposely shaped to push upwards bottom-settled matter in containers using a stirring or a back and forth reciprocal motion.

### SUMMARY OF THE INVENTION

This invention is a mechanical stirring device that is designed with the purpose of stirring fluids and paints such that bottom-settled heavier matter can be moved up for uniform mixing with the paint/stain/fluid in the container prior to the use of the paint/stain/fluid.

### EMBODIMENT 1

While several embodiments are possible, two embodiments are described below.

Because of the shortcomings of flat paddles in use today, this invention uses a paddle device shaped in the form of a twisted-screw or screw-conveyor so that, as the device is used to stir the paint in the container manually or otherwise, heavier paint matter at the bottom of the can is move up the screw-like paddle to enable mixing uniformly and quickly of the paint in the entire container.

### BRIEF DESCRIPTION OF DRAWINGS

FIG. 1: shows dominant devices used as paint stirrers today.

FIG. 2: shows a twisted metal strip device serving as a paint/liquid stirring paddle.

FIG. 3: shows an auger-shaped paddle.

FIG. 4: shows a conveyor-shaped paddle.

### DETAILED DESCRIPTION OF DRAWINGS

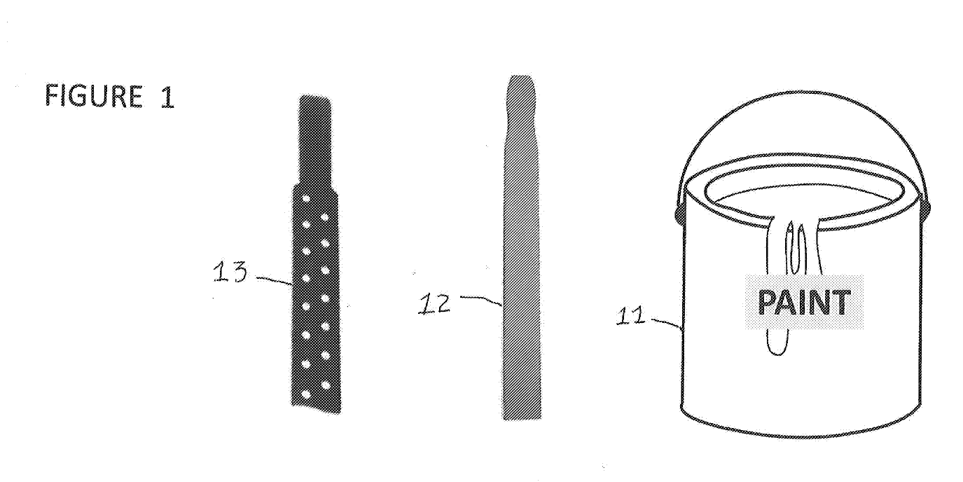

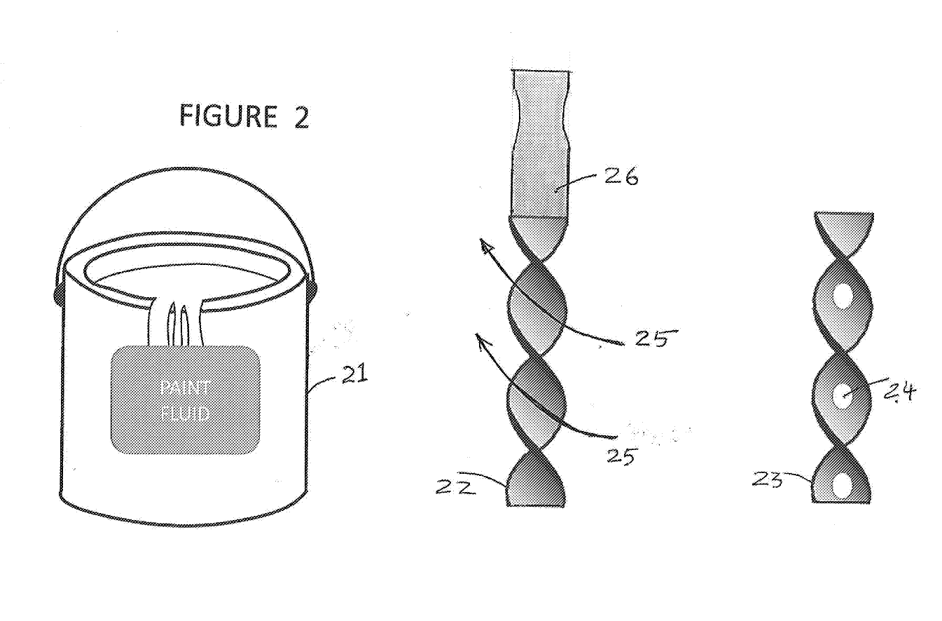

In FIG. 1, 11 is the paint container and 11 and 12 are commonly used paint stirrers that push paint sideways but have no capability to lift or move the paint upwards. FIG. 2 shows one embodiment of the invention, where a twisted metal strip or molded polymer 22 is used as the paddle to stir paint/fluid in a can/container 21. Another version of the invention shows the stirring device 23 with holes 24. Arrows 25 show the movement of paint from the bottom of the can to the top can as the device is used to stir the paint in the container. The paddle has a grip 26.

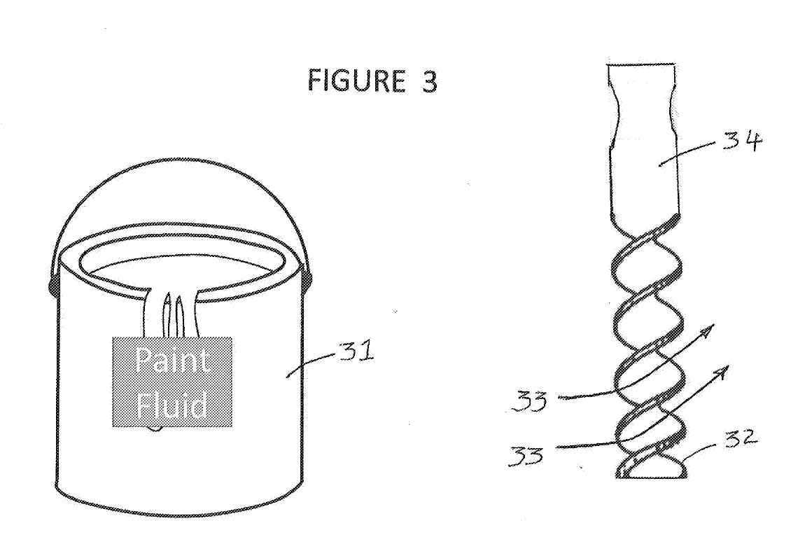

FIG. 3 shows an auger-shaped screw device 32 used as a paddle to stir paint or fluid in container 31. The handle or grip 34 is used to firmly stir the paint thereby causing the paint to move upwards as depicted by arrows 33.

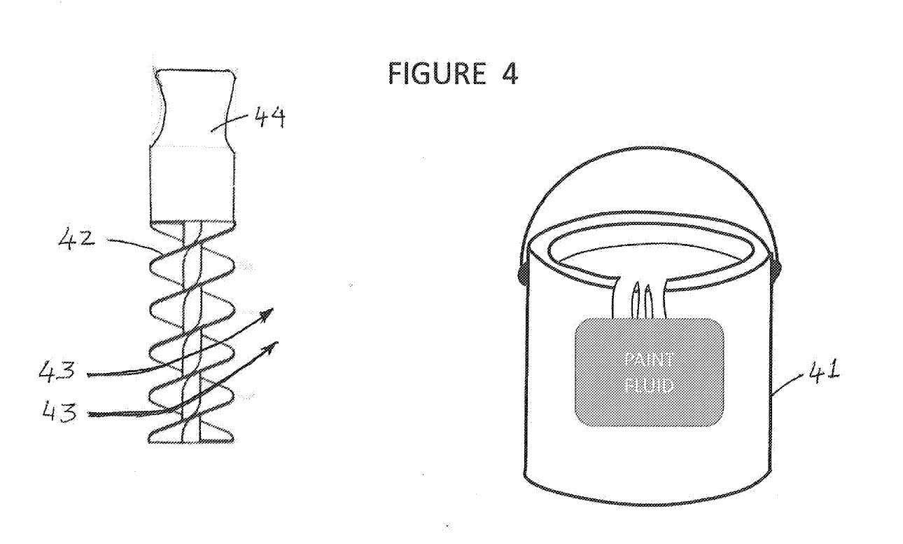

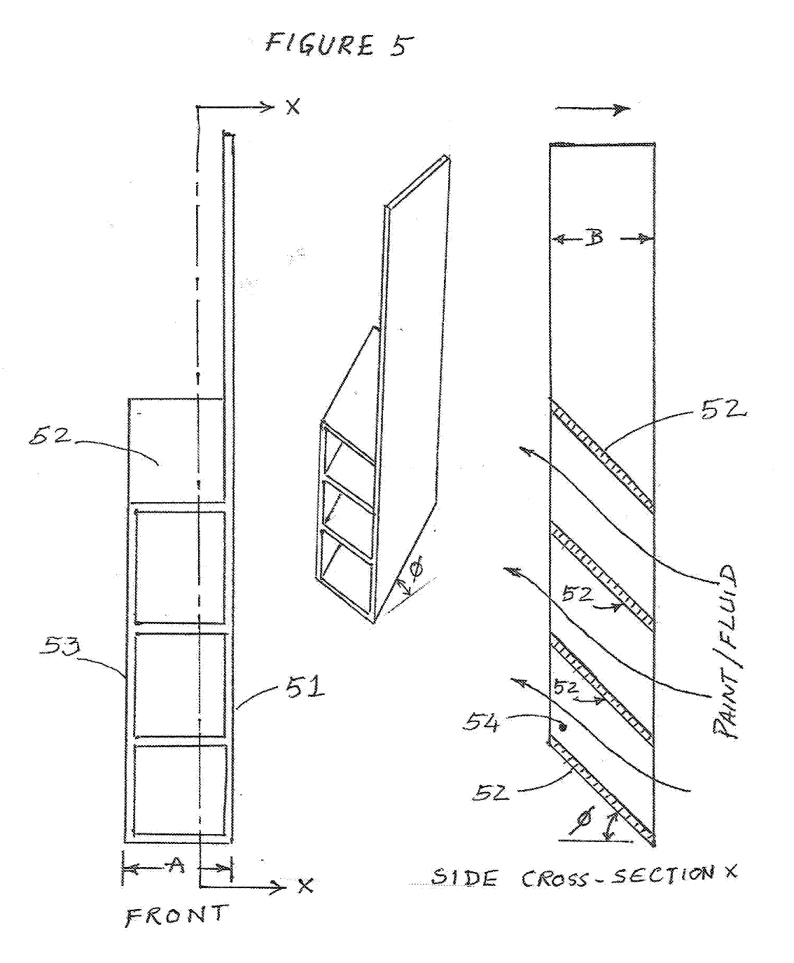

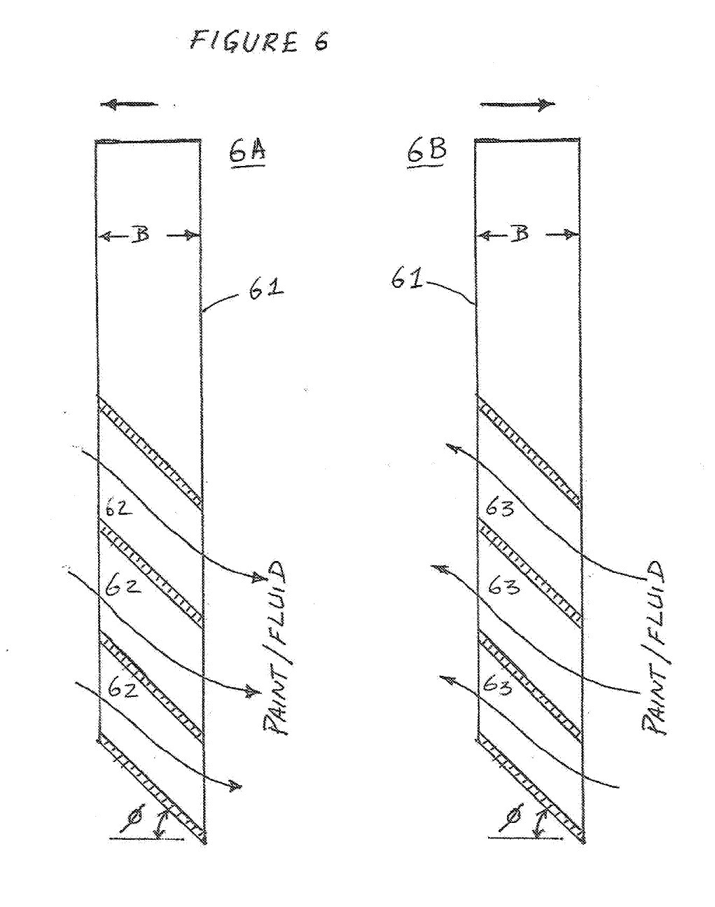

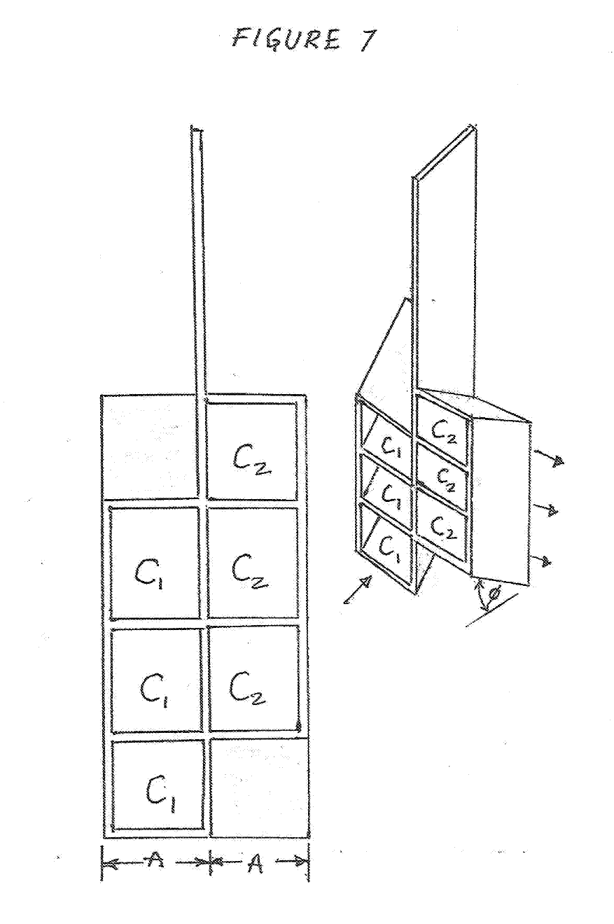

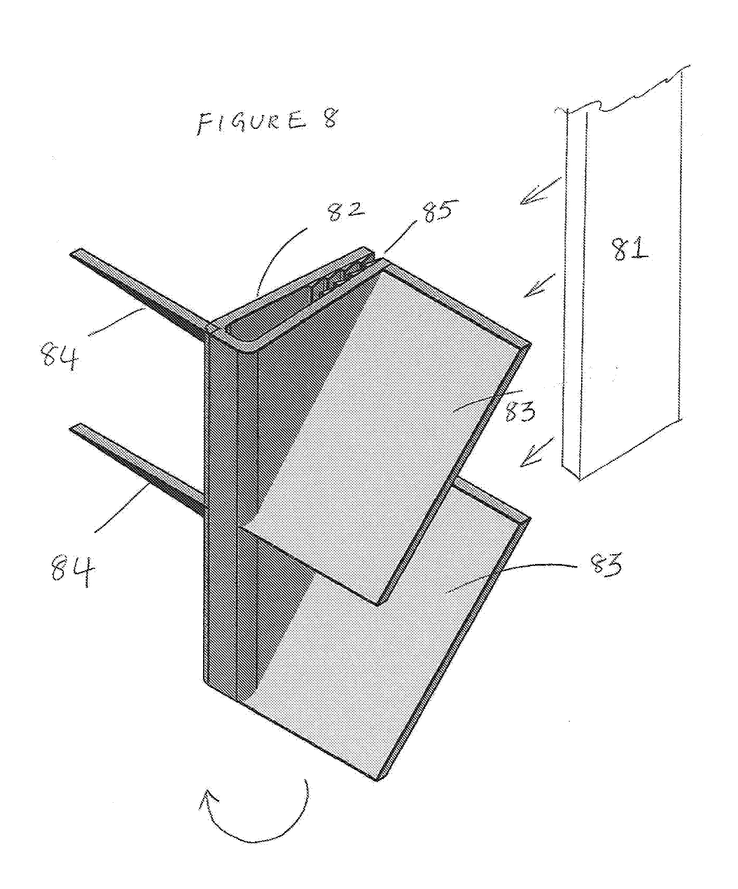

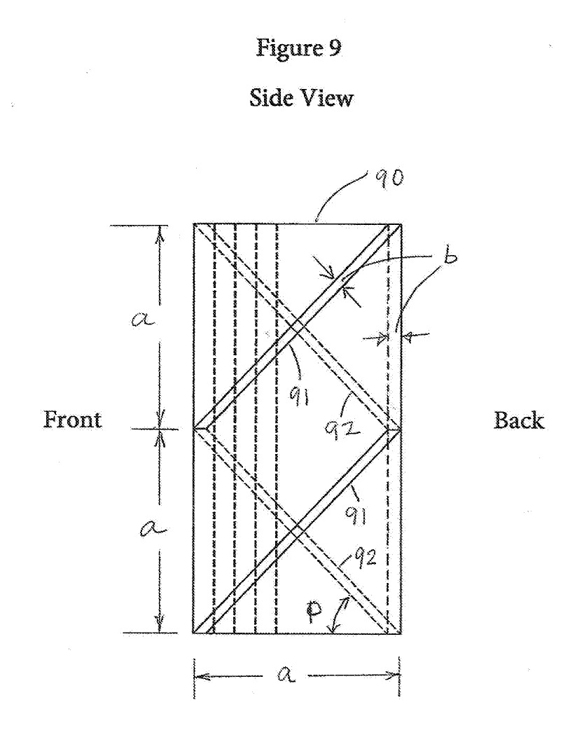

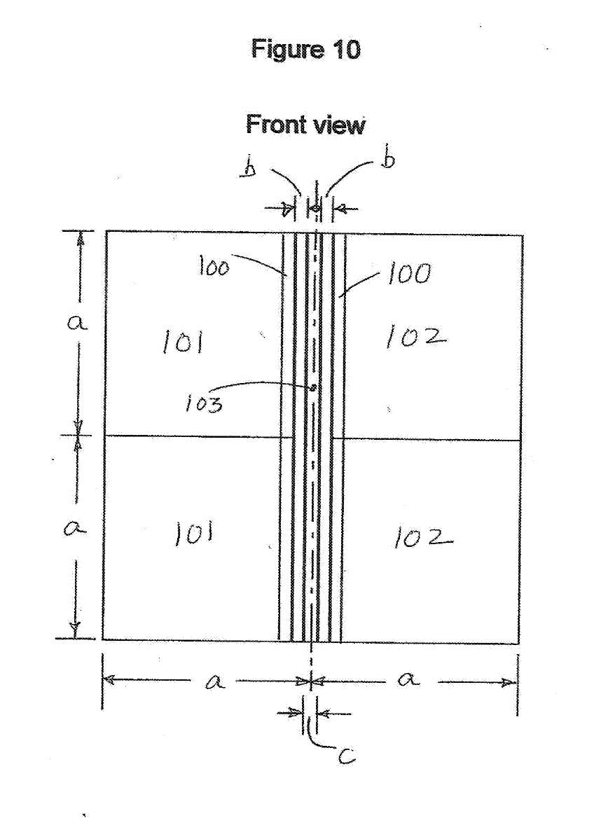

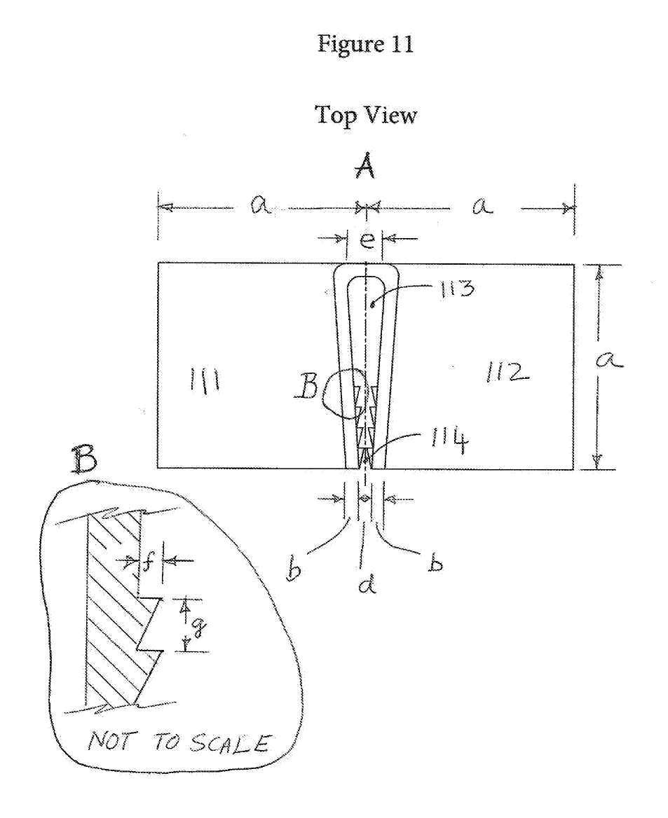

FIG. 4 shows 42, a conveyor-shaped paint/fluid stirrer for use in stirring paint/fluids. The grip 44 is used while stirring the paint in container 41 causing paint to move up the container as depicted by arrows 43.

### EMBODIMENT 2

### Brief Description of Drawings

FIG. 5 shows the paddle with built in three channels that push or lift paint from the bottom of container when the paddle is used to stir paint/fluids with a back and forth reciprocal motion.

FIG. 6 shows the flow of paint/fluid either upward or downward when the paddle is pushed reciprocally back and forth in a paint/fluid container.

FIG. 7 shows the device in FIG. 5 with two sets of channels with opposite effect when moved back and forth reciprocally; one set of channels pushing the bottom-settled matter upwards, while another set of channels pushing the lighter fluid from the top to the bottom for uniform mixing of bottom-settled heavier matter with the rest of the paint/stain/fluid.

### DETAILED DESCRIPTION OF DRAWINGS

In FIG. 5, the vertical paddle 51 of width B, has three built-in channels of width A formed by four horizontal members 52, and 53, a vertical member. The channels are inclined upwards at an angle Phi so that, when the paddle is moved left to right, the cross-section X of the paddle shows heavier, bottom-settled matter of the paint/fluid is pushed upwards as depicted by the arrows.

In FIG. 6, the arrow above paddle 61 shows that the paddle is moved right to left in FIG. 6A causing the fluid to be pushed downwards through three channels 62 inclined downwards. The arrow above paddle 61 in FIG. 6B shows paddle 61 is being moved left to right causing the bottom-settled paint/fluid to be pushed upwards through the three channels 63 in the figure. Thus, the to-and-fro reciprocal motion of paddle 61 moves the paint upward in one direction, moves the paint downwards on the return stroke of the paddle.

FIG. 7 shows the integration of two paddles into one with each side of the paddle pushing the paint or fluid in opposite direction to each other; channels C1 push paint or fluid upwards while channels C2 push paint/fluid downwards during a single stroke of the paddle for quicker and better mixing of the paint/fluid being stirred with paddle 71. Paddle 71 may be moved reciprocally to-and-fro inside the container, and could be used as a conventional paddle stirrer too.

### EMBODIMENT 3

### Brief Description of Drawings

FIG. 8 shows an isometric view of a “turbine foot,” which is a tight-fitting attachment or clip to the foot of the common paint paddle made of wood, polymer or metal to enable the common paint stick or paddle to push the paint upwards during the typical circular motion of the paddle, while “mixing” or blending the paint.

FIG. 9 shows the side view of the “turbine foot.”

FIG. 10 shows the front view of the “turbine foot.”

FIG. 11 shows the top view of the “turbine foot.”

### DETAILED DESCRIPTION OF DRAWINGS 8-11

In FIG. 8, 81 is the typical flat wooden paint paddle or stick used for “mixing” or blending paint today. Item 82 is the “turbine foot” (TF) invention that can be tightly attached or clipped to the foot of the paddle by pushing the paddle hard into the slot 85 in the TF. Four blades 83 and 84 are shown on the opposite sides of the TF are inclined at 90 degrees to each other along their length (all possible inclinations are not shown in this embodiment). During the clockwise rotary motion of the paddle, blades 83 and 84 will move the paint upwards for the configuration shown in FIG. 8. The blades may be designed to curve upwards.

In FIG. 9, item 90 is the TF, where 91 and 92 are four blades. Dimension “a” of the TF could be varied; “a” could be made equal to the width of the paddle, as one option. The dimension “b” is the thickness of the blades and the entire structure including the flanges of the clip making up the slot for holding the paddle in FIG. 8. All the blades are inclined at 45 degrees for the given configuration—other inclinations may be used.

In the front view shown in FIG. 10, 100 are the two flanges of the clip, where 101 and 102 are the inclined blades attached to the flanges 100. The paddle is pushed into the slot 103 for a tight fit while stirring the paint or any fluid. The dimension “b” is the thickness of the flanges and the entire structure. The width of the slot between the two flanges on the open end is “c,” which is less than the thickness of the paddle to enable the paddle to be gripped tightly between the two flanges.

Top view in FIG. 11 has two parts, 11A, and 11B. In FIG. 11A, 111 and 112 are the tilted blades, 113 is the slot between the flanges that takes the paddle, and “e” is the width of the slot at the fixed end of the flanges, where the slot is at least equal to the thickness of the paddle or slightly greater. 114 shows the narrow end of the slot before the paddle is inserted, allowing the flanges to exert pressure on the paddle once it is forced into the slot. FIG. 11B shows the inside of the flanges that are serrations running from top to the bottom of the flange to give a more positive grip on the paddle, while the paint or fluid is stirred. Serrated flanges is an option to enhance the grip on the traditional paddle; flanges may be designed to provide strong enough grip on the paddle without the need for serrations inside the flanges.

It is noted that these are only three of the several other possible embodiments of this invention to lift the heavier settled substance from a container's bottom, while stirring paints or fluids for superior mixing.

What is claimed is:

1. A superior stirring or blending device for stirring or blending fluids and paints to effectively lift or elevate to the surface any and all pigments and heavier components of the fluid/paint that may fall out of colloidal suspension and tend to settle to the bottom of containers, comprising:
a. an elongated flat portion with a upper end and a lower end;
b. the upper end of the elongated portion shaped to serve as a firm one-handed grip to use the said elongated portion as a stirrer;
c. the elongated portion below the grip twisted from the bottom end of the elongated to the grip to produce a twisted stirrer;
d. the twisted lower end of the stirrer may be inserted vertically into the paint/fluid can that need stirring;
e. While stirring or blending the paint/fluid, the lower twisted end of the paddle, because of its twisted shape, pushes upwards as well as sideways the settled pigments and heavier substance from the bottom of the container.

2. The superior stirring or blending device in claim 1 is made in the shape of an auger instead of a twisted flat piece.

3. The superior stirring or blending device in claim 1 is made in the shape of a screw conveyor instead of the twisted flat piece.

4. A superior stirring or blending device for stirring fluids and paints to effectively lift or elevate to the surface any pigments and heavier components of the fluid/paint that may or may not be held in colloidal suspension but tend to settle to the bottom of containers, comprising;
f. an elongated flat portion with an upper end and a lower end;
g. the upper end shaped to serve as a firm one-handed grip;
h. one or more inclined channels on the elongated flat portion that push or elevate heavier substances from the bottom of the container when stirred, or when the stirrer is moved to-and-fro in a reciprocal motion;
i. a composite stirrer, where two sets of the inclined channels positioned in opposition to each other such that one set of channels move bottom-settled paint matter from the bottom towards the top, while simultaneously move lighter fluid from the top to the bottom for uniform mixing of lighter and heavier paint/stain/fluid matter.

5. The superior stirring or blending device in claim 4 where the inclined channels to push and guide the settled heavier matter upwards may take a linear or curved shape.

6. The devices in claims 1 and 4 may be motorized or automated to be used at appropriate speeds for reciprocal or circular motion in larger containers of paints or fluids.

7. A superior paint or fluid stirring or blending device that can be attached or clipped to the foot of the common paint or fluid stirring paddle or stick, consisting:
a. One or more blades that are inclined to push the paint from the bottom of the container to the top during the typical circular motion of the paddle inside a can filled with paint or fluids, where heavier matter is settled to the bottom; and
b. A slot or clip in the device to take the paddle and grip it firmly, while the device is used with the paddle to stir, blend or “mix” heavy paint or other fluids.

8. The device in claim 7 made of metal, wood or polymers/plastics of appropriate thickness and properties to stir heavy paint, and to grip the paddle or stick without falling off during a vigorous stirring or blending action.
